(19) United States
(12) Patent Application Publication
(10) Pub. No.: US 2017/0264057 A1
(43) Pub. Date: Sep. 14, 2017

(54) NON-REVERSIBLE PLUG CONNECTOR FOR DEVICE CHARGING

(71) Applicant: David Baum, Orem, UT (US)

(72) Inventor: David Baum, Orem, UT (US)

(21) Appl. No.: 15/067,668

(22) Filed: Mar. 11, 2016

(51) Int. Cl. H01R 24/62; H02J 7/00; H01R 13/66

(52) U.S. Cl. CPC H01R 24/62; H01R 13/6691; H02J 7/0052; H01R 2107/00

(57) ABSTRACT

A non-reversible plug connector for providing power to a host device. The non-reversible plug connector includes a connector having a plurality of contacts, the plurality of contacts configured to make electrical contact with at least some pins within a receptacle connector of the host device. The non-reversible plug connector also includes control circuitry operatively coupled to at least some of the plurality of contacts. The control circuitry is configured to receive a checksum from the host device, verify whether the checksum is correct and when the checksum is correct, powering the host device.

### CROSS-REFERENCE TO RELATED APPLICATIONS

Not applicable.

### BACKGROUND OF THE INVENTION

Connectors are ubiquitous and are used in variety of applications for coupling two electronic devices. Most connectors usually have some sort of contacts that facilitate transmission of signals between the devices connected using a connector. Conventionally, each contact in a connector has a specific pre-assigned function. In other words, each contact in a connector is designated to carry a certain type of signal, e.g., power, data, etc.

However, often this functionality is not needed. Specifically, most of the time a user plugs a connector into an electrical device it is for the single purpose of charging the electrical device. That is, the user normally doesn't need data connection, instead the user just wants to charge the battery on the device. Nevertheless, in order to achiever charging the user must connect using a connector that is capable of data transfer even though that functionality is note desired.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a non-reversible plug connector for providing power to a host device. The non-reversible plug connector includes a connector having a plurality of contacts, the plurality of contacts configured to make electrical contact with at least some pins within a receptacle connector of the host device. The non-reversible plug connector also includes control circuitry operatively coupled to at least some of the plurality of contacts. The control circuitry is configured to receive a checksum from the host device, verify whether the checksum is correct and when the checksum is correct, powering the host device.

Another example embodiment includes a non-reversible plug connector for providing power to a host device. The non-reversible plug connector includes a body, a tab portion extending from the body and a contact region on the tab. The non-reversible plug connector additionally includes a connector within the contact region having a plurality of contacts, the plurality of contacts configured to make electrical contact with at least some pins within a receptacle connector of the host device. The non-reversible plug connector also includes control circuitry operatively coupled to at least some of the plurality of contacts. The control circuitry is configured to receive a checksum from the host device, verify whether the checksum is correct and when the checksum is correct, powering the host device.

Another example embodiment includes a method for establishing a connection protocol. The method includes receiving a checksum from the host device verifying whether the checksum is correct. The method also includes when the checksum is incorrect taking no action. The method further includes when the checksum is correct sending feedback to the host device if the checksum is correct and powering the host device.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of the plug connector;

FIG. 1B illustrates an opposing side view of the plug connector;

FIG. 1C illustrates an end view of the plug connector;

FIG. 1D illustrates a cross-sectional view of the plug connector;

FIG. 2 illustrates a pin-out configuration for a connector; and

FIG. 3 is a flowchart illustrating a method for a connection protocol.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

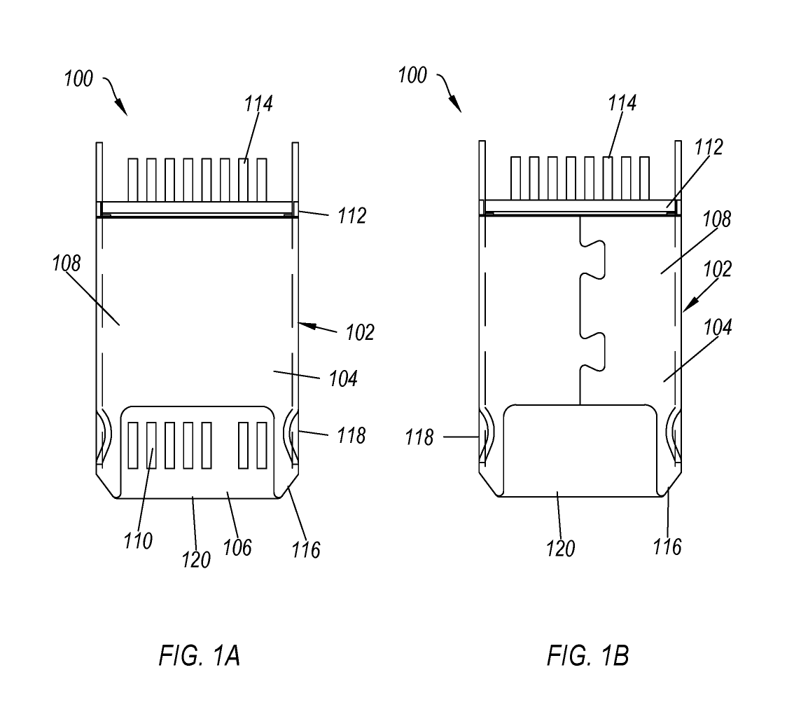

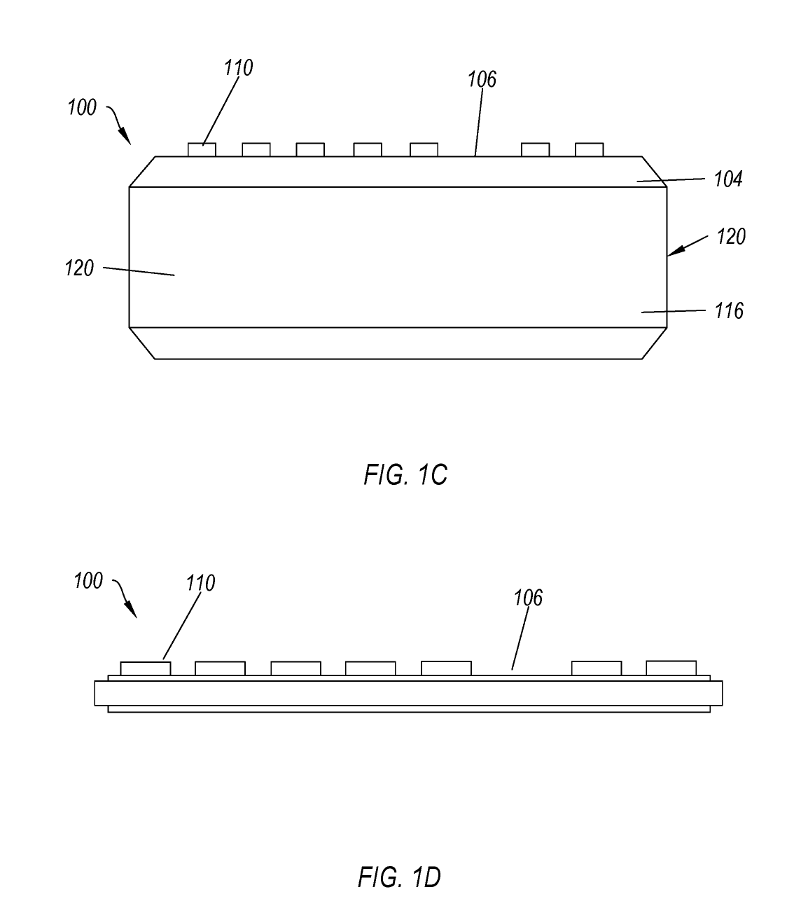

FIGS. 1A, 1B, 1C and 1D (collectively “FIG. 1”) illustrate a non-reversible plug connector 100 (or accessory-side connector 100). FIG. 1A illustrates a side view of the plug connector 100; FIG. 1B illustrates an opposing side view of the plug connector 100; FIG. 1C illustrates an end view of the plug connector 100; and FIG. 1D illustrates a cross-sectional view of the plug connector 100. Plug connector 100 includes a body 102 and a tab portion 104. Body 102 is shown in FIG. 1 in transparent form (via dotted lines) so that certain components inside the body are visible. A cable (not shown) may be attached to body 102 and tab portion 104 and extends longitudinally away from body 102 in a direction parallel to the length of the connector 100. Tab 104 is sized to be inserted into a corresponding receptacle connector during a mating event with an electronic device and includes a contact region 106 formed on a surface 108 of tab 104. In one particular embodiment, tab 104 is approximately 6.6 mm wide, approximately 1.5 mm thick and has an insertion depth (i.e., the distance from the tip of tab 104) of approximately 9.2 mm. These dimensions can be critical to ensure that the plug connector 100 is capable of attaching to an electronic device which uses an Apple Lightning™ connector. As used in the specification and the claims, the term approximately shall mean that the value is within 10% of the stated value, unless otherwise specified.

A plurality of contacts 110 can be formed in contact region 106 such that, when tab 104 is inserted into a corresponding receptacle connector, contacts 110 in region 106 are electrically coupled to at least some corresponding pins in the receptacle connector. In some embodiments, contacts 110 are self-cleaning wiping contacts that, after initially coming into contact with a receptacle connector contact during a mating event, slide further past the receptacle connector contact with a wiping motion before reaching a final, desired contact position.

As an example, in one embodiment an ID module is embodied within an IC 112 operatively coupled to the contacts 110 of plug connector 100. The ID module can be programmed with identification and configuration information about the connector and/or its associated accessory/adapter that can be communicated to a host device during a mating event. As another example, an authentication module programmed to perform an authentication routine, for example a public key encryption routine, with circuitry on the host device can be embodied within an IC 112 operatively coupled to connector 100. The ID module and authentication module can be embodied within the same IC 112 or within different ICs. As still another example, a current regulator can be embodied within the IC 112. The current regulator can be operatively coupled to contacts that are able to deliver power to charge a battery in the host device and regulate current delivered over those contacts to ensure a constant current regardless of input voltage and even when the input voltage varies in a transitory manner.

Bonding pads 114 can also be formed within body 102 near the end of a printed circuit board (“PCB” not shown). Each bonding pad can be connected to a contact or contact pair within region 106. Wires (not shown) can then be soldered to the bonding pads 114 to provide an electrical connection from the contacts to circuitry within an accessory associated with connector 100. In some embodiments, however, bonding pads 114 are not necessary and instead all electrical connections between the contacts and components of connector 100 and other circuitry within an accessory are made through traces on a PCB that the circuitry is coupled to and/or by interconnects between multiple PCBs within the accessory.

The structure and shape of tab 104 is defined by a ground ring 116 that can be made from stainless steel or another hard conductive material. Connector 100 includes retention features 118 formed as curved pockets in the sides of ground ring 116 that double as ground contacts.

The plug 102 can include a cap 120. Cap 120 can be made from a metal or other conductive material and can extend from the distal tip of connector 100 along the side of the connector towards body 102 either fully or partially surrounding contacts 110 formed in contact region 106 in the X and Y directions. In some embodiments, cap 120 can be grounded in order to minimize interference that may otherwise occur on contacts 110 of connector 100 and can thus be referred to as a ground ring, e.g., ground ring 116.

Contacts 110 are mounted only on a single side of the plug 100. Contacts 110 can be made from a copper, nickel, brass, a metal alloy or any other appropriate conductive material. Spacing is consistent between each of the contacts 110 with the exception of the spacing between the second and third contacts 110 (or fifth and sixth contacts 110 depending on which counting direction is chosen). That is if an additional contact 110 were present between the second and third contacts 110 spacing of all adjacent contacts 110 would be equidistant. When connector 100 is properly engaged with a receptacle connector, each of contacts 110 is in electrical connection with a corresponding contact of the receptacle connector.

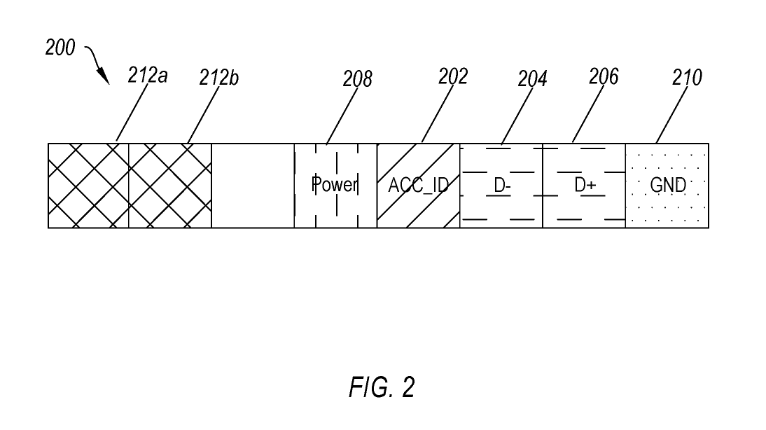

FIG. 2 illustrates a pin-out configuration for a connector 200. Connector 200 includes an accessory ID contact 202 to carry the identification signals between the accessory and the portable electronic device. Connector 200 can have a first data contact 204 and a second data contact 206. First data contact 204 and second data contact 206 are shorted with one another to achieve the correct charging profile. Connector 200 may further include host power contact 208. Host power contacts 208 can carry power to the host device that is mated with connector 200. For example, plug connector 200 may be part of a power supply system designed to provide power to the host device and host power contact carries power from the power supply to the host device, e.g., to charge a battery in the host device. Connector 200 may further include ground contact 210. The ground contacts provide a ground path for connector 200. Connector 200 includes two additional contacts 212a and 212b that do not provide any electrical connections.

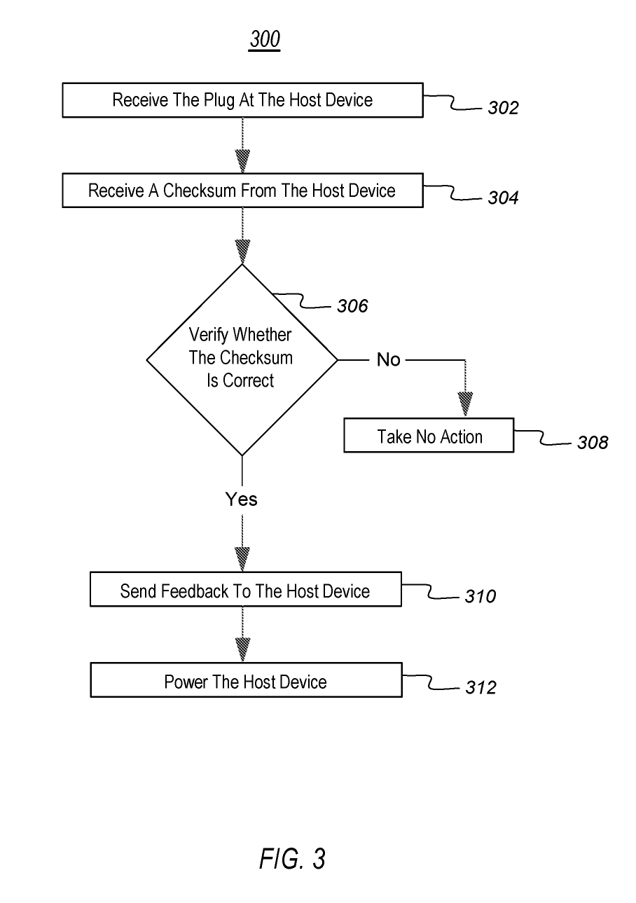

FIG. 3 is a flowchart illustrating a method 300 for a connection protocol. The connection protocol allows the host device to verify the plug as authentic and capable of charging the device. That is the connection protocol allows for a connection between the host device and the plug that allows power to be supplied to the host device via the plug. The method 300 will be described, exemplarily, with reference to the plug 100 of FIG. 1. Nevertheless, one of skill in the art can appreciate that the method 300 can be used with a plug other than the plug 100 of FIG. 1.

FIG. 3 shows that the method 300 can include receiving 302 the plug at the host device. The host device can include any device configured to receive the plug such as a phone, tablet, laptop or other electronic device. The host device has a pin that corresponds to each the contacts on the plug and may have additional pins that make no connection with contacts on the plug. That is, for each contact on the plug there is a pin in the host device which is in contact with each of the contacts in the plug after insertion 302.

As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. As a result, the phrase “configured to” reaches well beyond merely describing functional language or intended use since the phrase actively recites an actual state of configuration.

FIG. 3 also shows that the method 300 can include receiving 304 a checksum from the host device. The checksum is received 304 at an accessory ID contact. A checksum or hash sum is a small-size datum from a block of digital data for the purpose of detecting errors.

FIG. 3 further shows that the method 300 can include verifying 306 whether the checksum is correct. Specifically, the checksum ensures that the host device and plug are capable of connection to one another.

FIG. 3 additionally shows that the method 300 can include taking 308 no action if the checksum is incorrect. If the checksum is incorrect then the plug and the host device are incompatible with one another. Thus, data signals or power could damage the host device, the plug, or both. Therefore, no action is taken 308 in order to prevent damage from occurring.

FIG. 3 moreover shows that the method 300 can include sending 310 feedback to the host device if the checksum is correct. The feedback indicates to the host device that the plug is compatible and that charging can begin. That is, the feedback allows the plug to be verified by the host device just as the host device was verified by the plug. In the pin configuration of FIG. 2, shorting the first data contact 204 and the second data contact 206 ensures that the feedback string is correct and that the host device will accept the plug.

FIG. 3 also shows that the method 300 can include powering 312 the host device. Powering 312 the host device includes providing power to the host device via the power contact. I.e., the plug sends electrical power to the host device to either power the host device, charge the battery of the host device or for any other desired purpose.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A non-reversible plug connector for providing power to a host device, the non-reversible plug connector comprising:
a connector having a plurality of contacts, the plurality of contacts configured to make electrical contact with at least some pins within a receptacle connector of the host device; and
control circuitry operatively coupled to at least some of the plurality of contacts, wherein the control circuitry is configured to:
receive a checksum from the host device;
verify whether the checksum is correct; and
when the checksum is correct, powering the host device.

2. The non-reversible plug connector of claim 1, wherein the control circuity is further configured to:
take no action when the checksum is incorrect.

3. The non-reversible plug connector of claim 1, wherein the control circuity is further configured to:
provide feedback to the host device when the checksum is correct, the feedback configured to allow the host device to verify compatibility with the non-reversible plug connector.

4. The non-reversible plug connector of claim 1, wherein at least one of the plurality of contacts includes a power contact.

5. The non-reversible plug connector of claim 4, wherein powering the host device includes providing power to the host device via the power contact.

6. The non-reversible plug connector of claim 1, wherein at least one of the plurality of contacts includes a ground contact.

7. The non-reversible plug connector of claim 1, wherein at least one of the plurality of contacts includes an accessory ID contact.

8. The non-reversible plug connector of claim 1, wherein at least one of the plurality of contacts includes a first data contact.

9. The non-reversible plug connector of claim 8, wherein at least one of the plurality of contacts includes a second data contact.

10. The non-reversible plug connector of claim 9, wherein the first data contact is shorted to the second data contact.

11. The non-reversible plug connector of claim 1, wherein:
the plurality of contacts includes exactly seven contacts;
the receptacle connector of the host device includes exactly eight pins; and
the seven contacts of the non-reversible plug are each configured to make electrical contact with one of the eight pins and the remaining pin is not in electrical contact with any contacts.

12. The non-reversible plug connector of claim 9, wherein the pin that is not in electrical contact is the third pin.

13. A non-reversible plug connector for providing power to a host device, the non-reversible plug connector comprising:
a body;
a tab portion extending from the body;
a contact region on the tab;
a connector within the contact region having a plurality of contacts, the plurality of contacts configured to make electrical contact with at least some pins within a receptacle connector of the host device; and
control circuitry operatively coupled to at least some of the plurality of contacts, wherein the control circuitry is configured to:
receive a checksum from the host device;
verify whether the checksum is correct; and
when the checksum is correct, powering the host device.

14. The non-reversible plug connector of claim 13, wherein the width of the tab is approximately 6.6 mm.

15. The non-reversible plug connector of claim 13, wherein the thickness of the tab is approximately 1.5 mm.

16. The non-reversible plug connector of claim 13, wherein the insertion depth of the tab is approximately 9.2 mm.

17. The non-reversible plug connector of claim 13 further comprising one or more retention features.

18. The non-reversible plug connector of claim 13, wherein the spacing between the contacts in the plurality of contacts is equidistant except for the spacing between one pair of contacts.

19. A method for establishing a connection protocol, the method comprising:
receiving a checksum from the host device;
verifying whether the checksum is correct;
when the checksum is incorrect:
taking no action; and
when the checksum is correct:
sending feedback to the host device if the checksum is correct; and
powering the host device.

20. The method of claim 19, further comprising:
receiving the plug at the host device.
